(19) United States
(12) Patent Application Publication
(10) Pub. No.: US 2007/0107963 A1
(43) Pub. Date: May 17, 2007

(54) Rapid-Assembly Battery Structure of Electric Scooter

(75) Inventor: Chien-Liang Chiu, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: WU'S TECH CO., LTD., Hsinchu (TW)

(21) Appl. No.: 11/164,159

(22) Filed: Nov. 12, 2005

(51) Int. Cl. B60R 16/04

(52) U.S. Cl. 180/68.5

(57) ABSTRACT

A rapid-assembly battery structure of an electric scooter is disclosed. The rapid-assembly battery structure of the present invention comprises a scooter body. An accommodating tank is provided in an upper portion of the scooter body so as to accommodate a battery housing. Two electricity-conductive pieces are provided on the interior bottom surface of the accommodating tank, and two electrode plates are provided on the underside of the battery housing so that the battery may be electrically connected with the scooter after the battery housing is fitted into the accommodating tank. The top surface of the battery is provided with a handle so that a user may use the handle to move the battery housing around. Also, another battery housing may be additionally mounted on top of the battery housing so as to be used as a spare battery.

### BACKGROUND OF THE INVENTION

1. Field of the Invention

The present invention relates to a rapid-assembly battery structure of an electric scooter. In particular, the present invention relates to a rapid-assembly battery structure of an electric scooter with simple structure, easy operation, and enduring power, and thus facilitates replacement of battery in an electric scooter.

2. Description of the Prior Art

Since electric scooters are compact in structure and easy to operate, they are very suitable for short-distance transportation. Also, electric scooters are electric-powered without any fuels, thus they create no air pollution and cause only low noise. Such features conform to the requirements for environmental conservation and protection. Therefore, electric scooters have become a means of short-distance transportation for modern people. Especially, since the operation of an electric scooter is easy and requires little labor, it is very suitable for women or the elderly or handicapped people to use to go shopping or go to their intended places.

With regard to electric scooters, the design of battery has become a most important issue in this industry. Due to the limitations in current technology, the time interval and distance through which an electric scooter can travel by utilizing the power of battery are restricted to a certain range. Therefore, it is necessary to frequently charge the battery. However, the volume and weight of each electric scooter is bulky and unsuitable for towing, and the user of the electric scooter likely has low strength, the user can hardly handle the situation when the electric scooter is stranded because of low power.

Therefore, it is necessary to design the battery in the electric scooter for facilitating easy replacement thereof, such that the user can easily remove the low-power or damaged battery. After charging or replacing the battery, the user can put a newly energized battery into the electric scooter.

The existing battery structure of the electric scooter has some drawbacks as follows: the structure is complicated and not easy to detach—the detachment of the battery can only be carried out by a skilled worker using special tools. In view of the above, the inventor of the present invention has proposed a novel battery structure of the electric scooter, which is easy to assemble and lower in total volume without adversely affecting the external appearance of the electric scooter.

### SUMMARY OF THE INVENTION

The object of the present invention is to provide a rapid-assembly battery structure of an electric scooter so that can be easily, rapidly and stably assembled while not adversely affecting the external appearance of the electric scooter.

The rapid-assembly battery structure of the present invention comprises a scooter body. An accommodating tank is provided in an upper portion of the scooter body for accommodating a battery housing. Two electricity-conductive pieces are provided on the interior bottom surface of the accommodating tank, and two electrode plates are provided on the underside of the battery housing so that the battery may be electrically connected with the scooter after the battery housing is fitted into the accommodating tank. The top surface of the battery is provided with a handle so that a user may use the handle to move the battery housing around. With the above structure, a user may place the battery housing and hence the battery into the tank easily; when the user lets go of the handle, the battery may be electrically connected with the scooter automatically to power up the scooter.

### BRIEF DESCRIPTION OF THE DRAWINGS

The drawings disclose a preferred embodiment of the present invention which serves to exemplify the various advantages and objects hereof, and are as follows:

FIG. 1 shows a perspective view of a scooter with the rapid-assembly battery structure of the present invention;

FIG. 2 illustrates the condition before the battery housing is fitted into the tank.

FIG. 3 illustrates the condition after the battery housing is fitted into the tank.

FIG. 4 is a perspective view showing the underside of the battery housing of the present invention;

FIG. 5 is a perspective view showing how another battery housing may be stacked on top of the battery housing.

### DETAILED DESCRIPTION OF THE PREFERRED EMBODIMENT

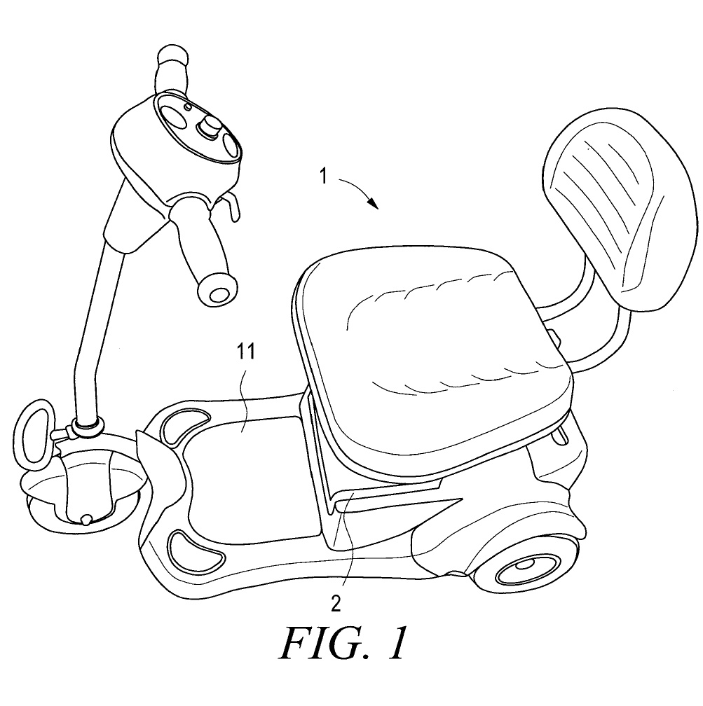

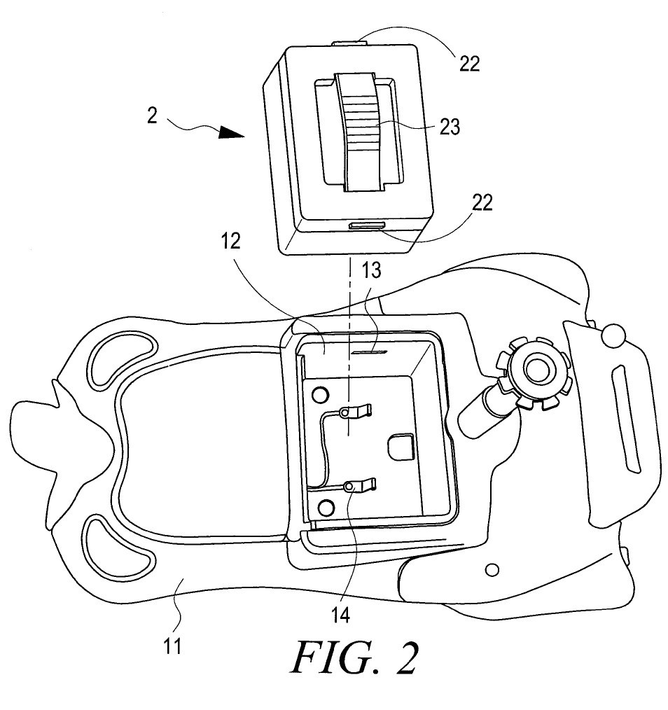

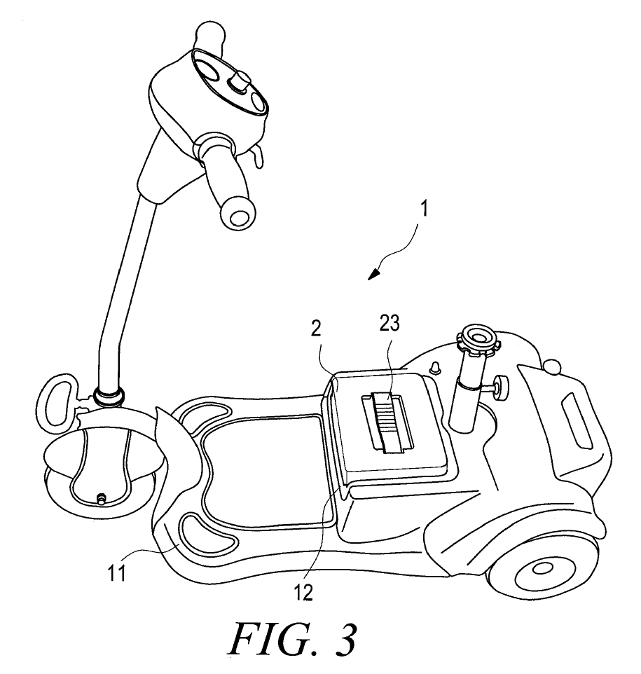

With reference to FIGS. 1 to 3, the present invention relates to a rapid-assembly battery structure of an electric scooter. The electric scooter 1 comprises a scooter body 11. The upper portion of the scooter body 11 is provided with an accommodating tank 12 so as to accommodate a battery housing 2. A battery may be carried in the battery housing 2 so that a user may carry the battery around easily.

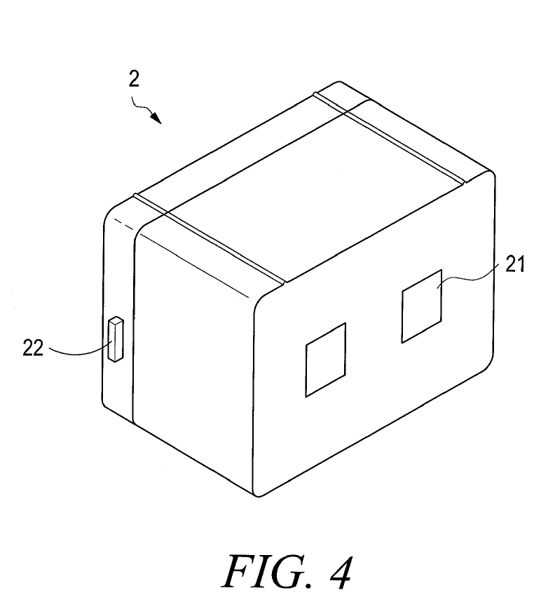

The interior bottom surface of the accommodating tank 12 is provided with two electricity-conductive pieces 14. Referencing to FIG. 4, the underside of the battery housing 2 is provided with two electrode plates 21. After the battery housing 2 is put into the accommodating tank 12, the electrode plates 21 are electrically connected with the electricity-conductive pieces 14, and thus the electricity of the battery housing 2 can be transmitted to the electric scooter 1. Furthermore, the electric scooter 1 is provided with an electric wire (not shown), which may be used to connect the battery with an external power supply source so as to charge up the battery held in the battery housing 2. A handle 23 is provided on the top surface of the battery housing 2 and is elastic. The handle 23 has two ends; each of the two ends is provided with a positioning piece 22; a positioning slot 13 is provided in each of two interior walls of the accommodating tank 12. When a user lifts up the handle 23, the weight of the battery housing 2 makes the two positioning pieces 22 retract into the housing 2 so that the battery housing 2 may be placed into the tank 12; after the user releases the handle 23, the elasticity of the handle 23 pushes the two positioning pieces 22 outwards so that the two positioning pieces 22 may engage with the positioning slots 13. Now, the battery housing 2 is fixedly held in the accommodating tank 12.

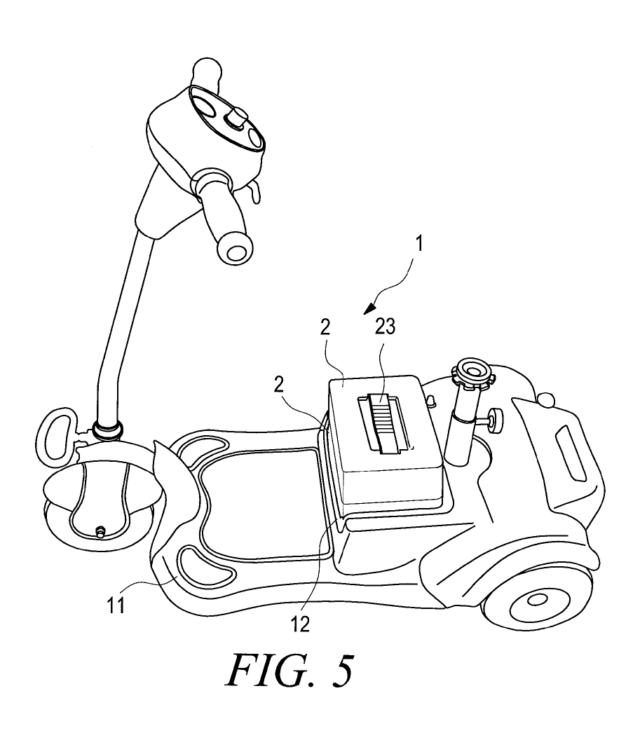

As shown in FIG. 5, because of the limited amount of electricity that a single battery can supply, one or more same or similar battery housings may be stacked up on the battery housing 2 so that at least another battery housing is available when the battery housing 2 is low on juice.

According to the present invention, with the rapid-assembly battery structure of an electric scooter, the battery can be attached to and detached from an electric scooter easily. Further, it is easy to mount such battery housing onto an electric scooter, and the battery housing can be easily designed to have an appealing appearance. In addition, at least one spare battery may also be mounted so that there is a spare battery readily available.

As an aid to the understanding of this invention, Table 1 lists all the reference numerals along with the description of the corresponding elements of the present invention.

Many changes and modifications in the abovementioned embodiment of the present invention can, of course, be carried out without departing from the scope thereof. Accordingly, to promote the progress in science and useful arts, the present invention is disclosed and is intended to be limited only by the scope of the appended claims.

TABLE 1
Reference Numerals of Essential Elements

| | |
|---|---|
| 1 Electric scooter | 11 Scooter body |
| 12 Accommodating tank | 13 Positioning slots |
| 14 Electricity-conductive pieces | |
| 2 Battery housing | |
| 21 Electrode plates | 22 Positioning pieces |
| 23 Handle | |

What is claimed is:

1. A rapid-assembly battery structure of an electric scooter, comprising:
an accommodating tank, which is to be placed in an upper portion of the body of an electric scooter so as to accommodate a battery housing;
two electricity-conductive pieces, provided on an interior bottom surface of the accommodating tank; and
a battery housing, comprising:
two electrode plates, provided on the underside of the battery housing;
a battery electrically connected to the two electrode plates; and
a handle, provided on the top surface of the battery housing so that a user may use the handle to move the battery housing around;
characterized in that the battery may be electrically connected with the electric scooter after the battery housing is fitted into the accommodating tank.

2. The rapid-assembly battery structure of an electric scooter according to claim 1, wherein another battery housing may be additionally mounted on top of the battery housing so as to be used as a spare battery.

3. The rapid-assembly battery structure of an electric scooter according to claim 2, wherein
the handle is elastic and has two ends, each of the two ends being provided with a positioning piece, and
a positioning slot is provided in each of two interior walls of the accommodating tank,
characterized in that the weight of the battery housing makes the two positioning pieces retract into the housing so that the battery housing may be placed into the tank when a user lifts up the handle, and that the elasticity of the handle pushes the two positioning pieces outwards so that the two positioning pieces may engage with the positioning slots and hence the battery housing is fixedly held in the tank after the user releases the handle.

4. An electric scooter with rapid-assembly battery structure, comprising:
a scooter body;
an accommodating tank, provided in an upper portion of the scooter body so as to accommodate a battery housing;
two electricity-conductive pieces, provided on an interior bottom surface of the accommodating tank; and
a battery housing, comprising:
two electrode plates, provided on the underside of the battery housing;
a battery electrically connected to the two electrode plates; and
a handle, provided on the top surface of the battery housing so that a user may use the handle to move the battery housing around;
characterized in that the battery may be electrically connected with the electric scooter after the battery housing is fitted into the accommodating tank.

5. The electric scooter with rapid-assembly battery structure according to claim 4, wherein another battery housing may be additionally mounted on top of the battery housing so as to be used as a spare battery.

6. The electric scooter with rapid-assembly battery structure according to claim 5, wherein
the handle is elastic and has two ends, each of the two ends being provided with a positioning piece, and
a positioning slot is provided in each of two interior walls of the accommodating tank,
characterized in that the weight of the battery housing makes the two positioning pieces retract into the housing so that the battery housing may be placed into the tank when a user lifts up the handle, and that the elasticity of the handle pushes the two positioning pieces outwards so that the two positioning pieces may engage with the positioning slots and hence the battery housing is fixedly held in the tank after the user releases the handle.
